(19) United States
(12) Patent Application Publication
(10) Pub. No.: US 2014/0090374 A1
(43) Pub. Date: Apr. 3, 2014

(54) EXHAUST AFTERTREATMENT SYSTEM AND METHOD

(71) Applicant: Praveen Chavannavar, Chennai (IN)

(72) Inventor: Praveen Chavannavar, Chennai (IN)

(73) Assignee: Caterpollar Inc., Peoria, IL (US)

(21) Appl. No.: 13/644,146

(22) Filed: Oct. 3, 2012

(51) Int. Cl. B01D 53/94; F01N 3/035; F02M 25/07; F01N 3/10; F02B 37/10

(52) U.S. Cl. 60/605.2; 60/274; 60/607; 60/278; 422/169; 422/170; 422/171; 423/212

(57) ABSTRACT

An engine exhaust gas treatment system includes an oxidation catalyst, a NO_{X} adsorber, and a turbine. The oxidation catalyst and the NO_{X} adsorber are fluidly connected to an exhaust manifold of the engine. The turbine is fluidly connected to, and downstream of the oxidation catalyst and the NOx adsorber.

### TECHNICAL FIELD

The present disclosure relates generally to exhaust gas aftertreatment systems. Specifically, an embodiment of the present invention relates to an aftertreatment system with an aftertreatment device upstream of a turbine.

### BACKGROUND

Complicated exhaust aftertreatment systems, developed in response to increased government regulation of engine emissions, can occupy large amounts of space in a vehicle or stationary application. This can make designing machine systems and components to fit in the remaining space difficult. Some engine and aftertreatment systems, engineered to meet new emission regulations, may have increased heat rejection. With less space, cooling system designs can be challenging. Many aftertreatment devices are more efficient when exhaust gasses are at higher temperatures. Since emission regulations must be met in a variety of conditions and temperatures, the aftertreatment components may be designed larger, and thus more expensive; or the engine may be run in a less fuel efficient manner; when exhaust gas temperatures are lower. For example, when the engine is first started, especially at low ambient temperatures, the exhaust system temperatures may be too low for an SCR system to reach a light-off condition. Solutions to this problem have included changing the engine operating mode, coating a larger area with a larger amount of catalyst, and/or heating the exhaust system in a variety of ways. All these solutions involve additional cost.

Many oxidation catalysts operate more efficiently at higher temperatures. Exhaust gasses are generally at higher temperatures, the closer the gasses are to an engine exhaust manifold. An oxidation catalyst disposed upstream of a turbine of a supercharger may perform more efficiently than if the oxidation catalyst was disposed downstream of the turbine, and may reach a light-off temperature in less time. U.S. Patent Application Publication 2011/0247327 A1 filed by Lambert et al. (hereafter referred to as “Lambert”) discloses an efficient system for treating exhaust gases from an engine by placing an oxidation catalyst upstream of a turbine. The system includes an exhaust separation passage that separates an exhaust gas flow received from the engine into a plurality of separate exhaust gas flows; a plurality of oxidation catalysts, each of which receives one of the plurality of separate exhaust gas flows; a flow combining passage that receives the plurality of separate exhaust gas flows and combines them into a re-combined exhaust gas flow; a turbocharger that receives the re-combined exhaust gas flow from the flow combining passage; and a selective catalytic reduction catalyst positioned downstream of the turbocharger.

Although the oxidation catalysts disclosed in Lambert are located upstream of the turbine, other aftertreatment devices may still occupy a large space, and may take some time to reach light-off temperature.

### SUMMARY OF THE INVENTION

Disclosed is an engine exhaust gas treatment system including an oxidation catalyst, a NO_{X} adsorber, and a turbine. The oxidation catalyst and the NO_{X} adsorber are fluidly connected to an exhaust manifold of the engine. The turbine is fluidly connected to, and downstream of the oxidation catalyst and the NOx adsorber.

Further disclosed is an engine exhaust gas treatment system including an oxidation catalyst, a turbine, a housing, and a particulate filter coated with a selective catalytic reduction catalyst. The oxidation catalyst is fluidly connected to an engine exhaust manifold. The turbine is fluidly connected to and downstream of the oxidation catalyst. The housing includes an inlet port and an outlet port, and defines a flow path between the inlet port and the outlet port. The housing is disposed downstream of the turbine. The particulate filter is arranged in the flow path.

Further disclosed is a method of treating exhaust gas. The method includes converting NO in the exhaust gas to NO₂ upstream of a turbine; and adsorbing and storing NO_{X} from the exhaust gas in an adsorbing location upstream of the turbine, when the temperature at the adsorbing location is in an adsorption temperature range. The method further includes determining an exhaust gas temperature at a reductant introduction location is above a decomposition temperature; and determining that a CDS is at or above a CDS light-off temperature. The method further includes introducing a reductant into the exhaust gas, in the reductant introduction location downstream of the adsorbing location, to form NH₃ in the exhaust gas after determining the exhaust gas temperature at the reductant introduction location is above a decomposition temperature and the CDS is above the CDS light-off temperature; and converting the NH₃ and NO_{X}, into N₂ and H₂O, in an NO_{X} conversion location downstream of the reductant introduction location.

### BRIEF DESCRIPTION OF THE DRAWINGS

FIG. 1 schematically depicts an exemplary embodiment of an engine system.

FIG. 2 schematically depicts an exemplary embodiment of an exhaust gas aftertreatment system.

FIG. 3 depicts a graph with exemplary plots of conversion efficiency verses temperature for diesel oxidation catalyst.

FIG. 4 depicts a graph with exemplary plots of nitrous oxide concentration at locations in an aftertreatment system verses temperature.

FIG. 5 depicts a graph with an exemplary plot of conversion efficiency verses temperature for a particulate filter coated with a SCR catalyst.

FIG. 6 depicts a graph with an exemplary plot of conversion efficiency verses temperature in an adsorption temperature range for a NO_{X} adsorber.

FIG. 7 depicts a graph with an exemplary plot of NO₂ concentration verses temperature in a desorption temperature range for a NO_{X} adsorber.

FIG. 8 depicts a flow chart of an exemplary method of treating exhaust gas.

### DETAILED DESCRIPTION

Reference will now be made in detail to specific embodiments or features, examples of which are illustrated in the accompanying drawings. Generally, corresponding or similar reference numbers will be used, when possible, throughout the drawings to refer to the same or corresponding parts.

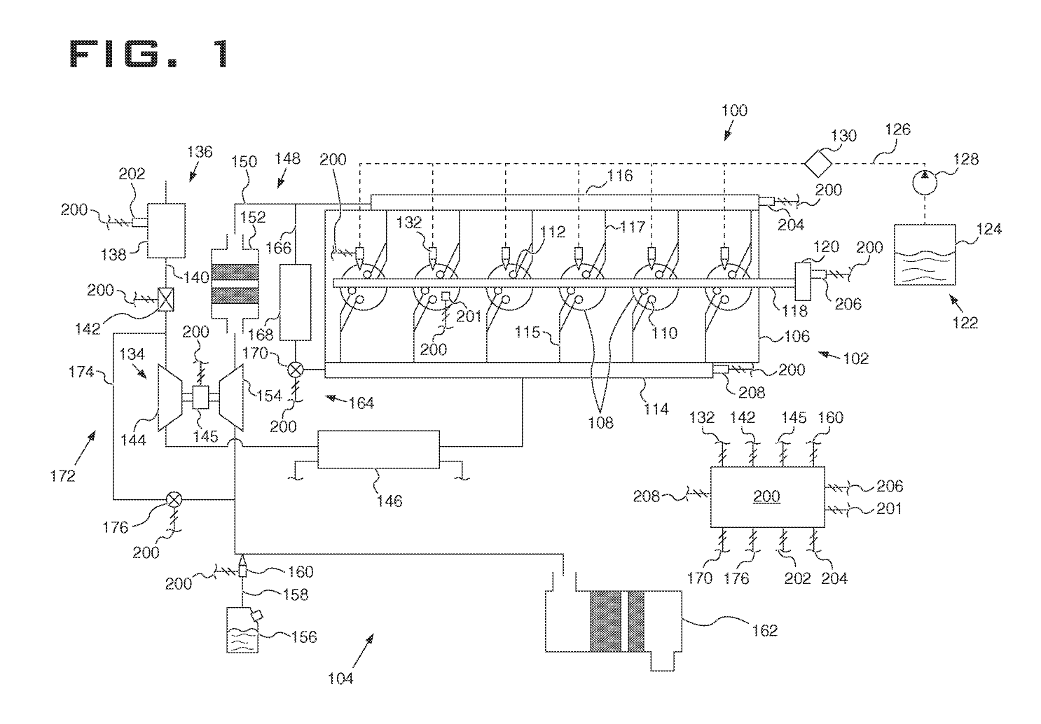

Referring now to FIG. 1, there is illustrated a block diagram representing an exemplary internal combustion engine system 100. The engine system 100 includes an internal combustion engine 102 and an aftertreatment system 104 for treating exhaust gases from the engine 102. In one embodiment, the engine 102 includes a diesel engine that combusts a mixture of air and diesel fuel. In alternative embodiments the engine 102 may include a gasoline engine, a natural gas engine, a turbine engine, or any combustion engine known in the art which emits exhaust gases which the aftertreatment system 104 may treat.

The illustrated internal combustion engine 102 includes an engine block 106 in which a plurality of combustion chambers 108 are disposed. Although six combustion chambers 108 are shown in an inline configuration, in other embodiments fewer or more combustion chambers 108 may be included or another configuration such as a V-configuration may be employed. The engine system 100 can be utilized in any suitable application including mobile applications such as motor vehicles, work machines, locomotives or marine engines, and in stationary applications such as electrical power generators.

Each combustion chamber 108 includes one or more intake valves 110, to supply air that is combusted with the fuel in the combustion chambers 108. A hollow runner or intake manifold 114 can be formed in or attached to the engine block 106 such that it extends over or proximate to each of the combustion chambers 108. The intake manifold 114 can communicate with an intake line 140 that directs air to the internal combustion engine 102. Fluid communication between the intake manifold 114 and the combustion chambers 108 can be established by a plurality of intake runners 115 extending from the intake manifold 114. The intake valves 110 can open and close to selectively introduce the intake air from the intake manifold 114 to the combustion chamber 108. While the illustrated embodiment depicts the intake valves 114 at the top of the combustion chamber 108, in other embodiments the intake valves may be placed at other locations such as through a sidewall of the combustion chamber 108.

To direct exhaust gas from the combustion cylinders 108 after combustion events, each combustion cylinder 108 includes one or more exhaust valves 112. An exhaust manifold 116 communicating with an exhaust line 150 may also be disposed in or proximate to the engine block 106. The exhaust manifold 116 can receive exhaust gasses by selective opening and closing of the one or more exhaust valves 112 associated with each combustion chamber 108. The exhaust manifold 116 can communicate with the combustion chambers 108 through exhaust runners 117 extending from the exhaust manifold 116.

To actuate the intake valves 110 and the exhaust valves 112, the illustrated embodiment depicts an overhead camshaft 118 that is disposed over the engine block 106 and operatively engages the valves 110, 112. As will be familiar to those of skill in the art, the camshaft 118 can include a plurality of eccentric lobes disposed along its length that, as the camshaft 118 rotates, cause the intake and exhaust valves 110, 112 to displace or move up and down in an alternating manner with respect to the combustion chambers 108. Movement of the valves 110, 112 can seal and unseal ports leading into the combustion chamber 108. The placement or configuration of the lobes along the camshaft 118 controls or determines the gas flow through the internal combustion engine 102.

As is known in the art, other methods exist for implementing valve 110, 112 and/or intake air and exhaust timing such as electronic, electrical and/or hydraulic actuators acting on the individual valve stems and the like. In some two stroke combustion engines, the intake valves may be replaced with a port which is opened and closed by the moving of a piston (not shown) within the combustion cylinder 108.

In the embodiment illustrated, the engine 102 has a variable cam timing, which enables the selective shifting and/or elongation of the opening stroke of the intake valves 110 and the exhaust valves 112. A phase angle of the camshaft 118 can be selectively altered via a specialized actuator 120, which is responsive to a command signal. In general, variable valve timing for the engine 102 can be accomplished in any known way, including the addition of devices and actuators that act on the valve pushrods to keep the respective valve 110, 112 open for a prolonged period, or close the valve 110, 112 in an early fashion. One example of a variable valve timing arrangement that can operate to shift valve 110, 112 timing includes a cam phaser configured to provide a predetermined phase rotation of the camshaft 118 relative to the engine crankshaft that results in a phase shift of valve 110, 112 opening and closing events during engine 102 operation. The actuators may be electric, hydraulic or any other device that is capable of acting on the pushrods to hold the respective intake valve 110 or exhaust valve 112 open and thereby vary the valve timing.

To supply the fuel that the engine 102 burns during the combustion process, a fuel system 122 is operatively associated with the engine system 100. The fuel system 122 includes a fuel reservoir 124 that can accommodate a hydrocarbon-based fuel such as liquid diesel fuel. Although only one fuel reservoir is depicted in the illustrated embodiment, it will be appreciated that in other embodiments additional reservoirs may be included that accommodate the same or different types of fuels that the combustion process may also burn. Because the fuel reservoir 124 may be situated in a remote location with respect to the engine 102, a fuel line 126 can be disposed through the engine system 100 to direct fuel from the fuel reservoir 124 to the engine 102. To pressurize the fuel and force it through the fuel line 124, a fuel pump 128 can be disposed in the fuel line. An optional fuel conditioner 130 may also be disposed in the fuel line 126 to filter the fuel or otherwise condition the fuel by, for example, introducing additives to the fuel, heating the fuel, removing water and the like.

To introduce the fuel to the combustion chambers 108, the fuel line 126 may be in fluid communication with one or more fuel injectors 132 that are associated with the combustion chambers 108. In the illustrated embodiment, one fuel injector 132 is associated with each combustion chamber 108 but in other embodiments a different number of injectors might be used. Additionally, while the illustrated embodiment depicts the fuel line 126 terminating at the fuel injectors 132, the fuel line may establish a fuel loop that continuously circulates fuel through the plurality of injectors 132 and, optionally, delivers unused fuel back to the fuel reservoir 124. Alternatively, the fuel line 126 may include a fuel collector volume or rail (not shown), which supplies pressurized fuel to the fuel injectors 132. The fuel injectors 132 can be electrically actuated devices that selectively introduce a measured or predetermined quantity of fuel to each combustion chamber 108. In other embodiments, introduction methods other than fuel injectors 132, such as a carburetor or the like, can be utilized.

To assist in directing the intake air into the internal combustion engine 102, the engine system 100 can include a supercharger 134. The supercharger 134 includes a compressor 144 disposed in the intake line 140 that compresses intake air drawn from the atmosphere and directs the compressed air to the intake manifold 114. Although a single supercharger 134 is shown, more than one such device connected in series and/or in parallel with another can be used. To power the compressor 144, a turbine 154 can be disposed in the exhaust line 150 and can receive pressurized exhaust gasses from the exhaust manifold 116. The pressurized exhaust gasses directed through the turbine 154 can rotate a turbine wheel having a series of blades thereon, which powers a shaft that causes a compressor wheel to rotate within the compressor 144 housing. To power the compressor 144 when energy from the turbine 154 is not sufficient to compress the intake air to a desired pressure for combustion, the supercharger 134 can include a supercharger assist system 145. In one exemplary embodiment the assist system 145 may include an electric motor. Other possible embodiments include a fly wheel, or a selective mechanical connection to the engine 102 output, through for example, a clutch. The assist system may be powered mechanically, electrically, hydraulically, pneumatically, or in other way known in the art.

An intake air system 136 can provide air to the engine 102. An air filter 138 to filter debris from intake air drawn from the atmosphere can be disposed on an air intake line 140 upstream of the compressor 144. The air intake line 140 may selectively fluidly connect the intake manifold 114 with the atmosphere through elements of the air intake system 136. In some embodiments, the engine system 100 may be open-throttled wherein the compressor 144 draws air directly from the atmosphere with no intervening controls or adjustability. In other embodiments, to assist in controlling or governing the amount of air drawn into the engine system 100, an adjustable governor or intake throttle 142 can be disposed along the intake line 140 between the intake air filter 138 and the compressor 144. Because the intake air may become heated during compression, an intercooler 146 such as an air-to-air heat exchanger can be disposed along the intake line 140 between the compressor 144 and the intake manifold 114 to cool the compressed air.

To direct exhaust gases from the engine 102 combustion process, the engine system 100 includes an exhaust system 148. To reduce emissions generated by the combustion process, by treating exhaust gasses before they are discharged to the atmosphere, the exhaust system 148 includes the aftertreatment system 104. The aftertreatment system 104 includes at least one after-treatment device disposed along the exhaust line 150 upstream of the turbine 154. Aftertreatment devices upstream of the turbine 154 may be disposed in a pre-turbine module 152. The aftertreatment system 104 may include one or more aftertreatment devices disposed along the exhaust line 150 downstream of the turbine 154. Aftertreatment devices disposed downstream of the turbine 154 may be disposed in a post-turbine module 162. One or more of the aftertreatment devices in the post-turbine module 162 may include a catalyst which requires a reductant be injected into the exhaust gases upstream of the post-turbine module 162 to be effective. The reductant may be stored in a reductant tank 156, supplied to the exhaust system 148 through a reductant line 158, and injected into the exhaust gases with reductant injector 160. To reduce noise emissions the exhaust system 148 may further include sound suppression devices (not shown).

To reduce emissions and assist adjusted control over the combustion process, the engine system 100 can mix the intake air with a portion of the exhaust gasses drawn from the exhaust system 104 through a system or process called exhaust gas recirculation (EGR). The EGR system forms an intake air/exhaust gas mixture that is introduced to the combustion chambers 108 along with the intake air. In one aspect, addition of exhaust gasses to the intake air displaces the relative amount of oxygen in the combustion chamber 108 during combustion that results in a lower combustion temperature and reduces the generation of nitrogen oxides. Two exemplary EGR systems 164, 172 are shown associated with the engine system 100 in FIG. 1, but it should be appreciated that these illustrations are exemplary and that either one, both, neither, or another EGR system known in the art can be used on the engine. It is contemplated that selection of an EGR system of a particular type may depend on the particular requirements of each engine 102 application.

In the first embodiment, a high-pressure EGR system 164 operates to direct high-pressure exhaust gasses to the intake manifold 114. The high-pressure EGR system 164 includes a high-pressure EGR line 166 that communicates with the exhaust line 150 downstream of the exhaust manifold 116 and upstream of the pre-turbine module 152 and the turbine 154 to receive the high-pressure exhaust gasses being expelled from the combustion chambers 108. The system is thus referred to as a high-pressure EGR system 164 because the exhaust gasses received have yet to depressurize through the pre-turbine module 152 and the turbine 154. In an alternative embodiment the high-pressure EGR line 166 may communicate with the exhaust line 150 downstream of the pre-turbine module 152 and upstream of the turbine 154. The high-pressure EGR line 166 is also in fluid communication with the intake manifold 114. To control the amount or quantity of the exhaust gasses combined with the intake air, the high-pressure EGR system 164 can include a high pressure EGR valve 170 disposed along the high-pressure EGR line 166. Hence, the ratio of exhaust gasses mixed with intake air can be varied during operation by adjustment of the high pressure EGR valve 170. Because the exhaust gasses may be at a sufficiently high temperature that may affect the combustion process, the high-pressure EGR system 164 can also include an EGR cooler 168 disposed along the high-pressure EGR line 166 to cool the exhaust gasses.

In the second embodiment, a low-pressure EGR system 172 directs low-pressure exhaust gasses to the intake line 140 before it reaches the intake manifold 114. The low-pressure EGR system 172 includes a low-pressure EGR line 174 that communicates with the exhaust line 150 downstream of the turbine 154 so that it receives low-pressure exhaust gasses that have depressurized through the pre-turbine module 152 and the turbine 154, and delivers the exhaust gasses upstream of the compressor 144 so the exhaust gasses can mix and be compressed with the incoming air. The system 172 is thus referred to as a low-pressure EGR system 172 because it operates using depressurized exhaust gasses. To control the quantity of exhaust gasses re-circulated, the low-pressure EGR line 174 can also include a low pressure EGR valve 176.

To coordinate and control the various systems and components associated with the engine system 100, the system 100 can include an electronic or computerized control unit, module, or controller 200. The controller 200 is adapted to monitor various operating parameters and to responsively regulate various variables and functions affecting engine 102 operation. The controller 200 can include a microprocessor, an application specific integrated circuit (ASIC), or other appropriate circuitry and can have memory or other data storage capabilities. The controller 200 can include functions, steps, routines, data tables, data maps, charts, and the like, saved in, and executable from, read only memory, or another electronically accessible storage medium, to control the engine system 100. Although in FIG. 1, the controller 200 is illustrated as a single, discrete unit, in other embodiments, the controller 200 and its functions may be distributed among a plurality of distinct and separate components. The single unit or multiple component controller 200 may be located on-board, and/or in a remote location. To receive operating parameters and send control commands or instructions, the controller 200 can be operatively associated with and can communicate with various sensors and controls on the engine system 100. Communication between the controller 200 and the sensors can be established by sending and receiving digital or analog signals across electronic communication lines or communication busses. In some embodiments the communication between the controller 200 and the sensors may be by radio, satellite, and/or telecommunication channels.

In one exemplary sensor embodiment, to monitor the pressure and/or temperature in the combustion chambers 108, the controller 200 may communicate with chamber sensors 201 such as a transducer or the like, one of which may be associated with each combustion chamber 108 in the engine block 106. The chamber sensors 201 can monitor the combustion chamber 108 conditions directly or indirectly. For example, by measuring the backpressure exerted against the intake or exhaust valves 110, 112, the controller 200 can indirectly measure the pressure in the combustion chamber 108.

In another exemplary sensor embodiment, to measure the flow rate, pressure and/or temperature of the air entering the engine 102, the controller 200 can communicate with an intake air sensor 202. The intake air sensor 202 may be associated with, as shown, the intake air filter 138 or another intake system component such as the intake manifold 114. The intake air sensor 202 may also determine or sense the barometric pressure or other environmental conditions in which the engine system 100 is operating.

In another exemplary sensor embodiment, the controller 200 can communicate with an intake manifold sensor 208, disposed in the intake manifold 114, and operable to sense or measure the conditions therein. To monitor the conditions such as pressure and/or temperature in the exhaust manifold 116, the controller 200 can similarly communicate with an exhaust manifold sensor 204 disposed in the exhaust manifold 116. From the temperature of the exhaust gasses in the exhaust manifold 116, the controller 200 may be able to infer the temperature at which combustion in the combustion chambers 108 is occurring.

In another exemplary sensor embodiment, to control the timing of the valves 110, 112, the controller 200 can communicate a camshaft control 206 that is operatively associated with the camshaft 118 and/or the specialized actuator 120. Alternatively, the controller 200 may communicate with and control any other device used to monitor and/or control valve timing.

In another exemplary sensor embodiment, to further control the combustion process, the controller 200 can communicate with injector controls of fuel injectors 132 operatively associated with the combustion chambers 108. The injector controls can selectively activate or deactivate the fuel injectors 132 to determine the timing of introduction, and the quantity of fuel, introduced by each fuel injector 132.

In embodiments having an intake air valve 142, the controller 200 can communicate with controls actuating the intake air valve to control the amount of air drawn into the engine system 100.

The controller 200 can also be operatively associated with either or both of the high-pressure EGR system 164 and the low-pressure EGR system 172. For example, the controller 200 can be communicatively linked to a high-pressure EGR control associated with the high pressure EGR valve 170 disposed in the high-pressure EGR line 166. Similarly, the controller 200 can also be communicatively linked to a low-pressure EGR control associated with the low pressure EGR valve 176 in the low-pressure EGR line 174. The controller 200 can thereby adjust the amount of exhaust gasses and the ratio of intake air/exhaust gasses introduced to the combustion process.

The controller 200 can also be communicatively linked to a control associated with the reductant injector 160 to adjustably control the timing and amount of reductant introduced to the exhaust gasses.

The controller 200 may monitor combustion, intake air, and exhaust gas characteristics to estimate the actual intake air pressure at the intake manifold 114, combustion chambers 108 and/or intake valves 110, and a desired pressure at those locations. The controller 200 can be communicatively linked to the supercharger assist system 145 to actuate the system and increase the power to the compressor 144 in response to situations such as, for example, the actual intake air pressure being lower than the desired pressure.

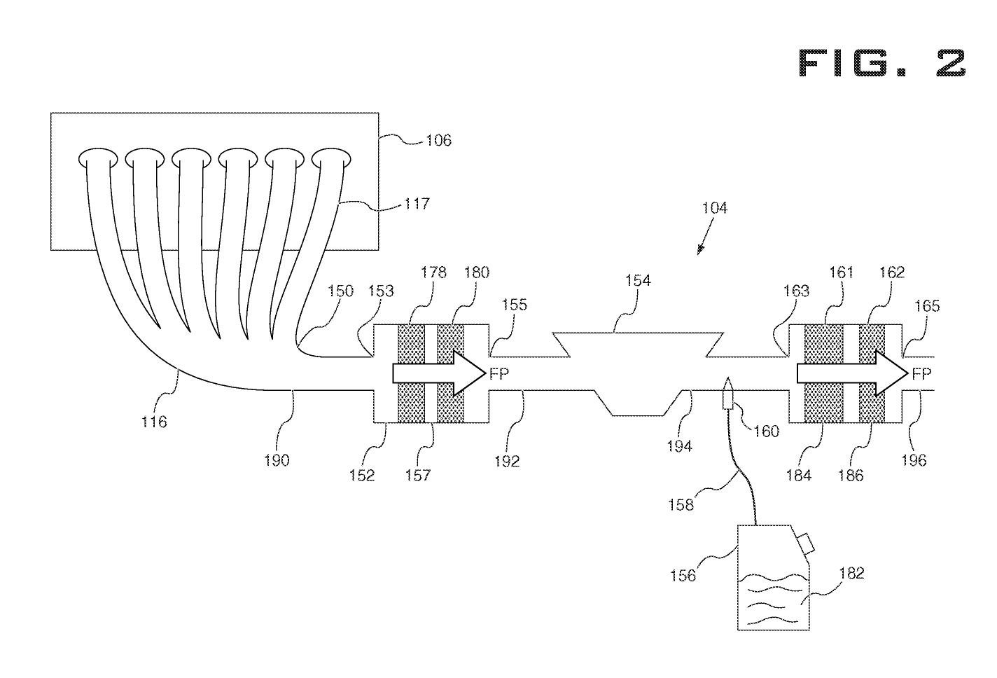

As best seen in relation to FIG. 2, the aftertreatment system 104 includes devices to reduce emissions in exhaust gasses as they flow from the engine 100, through the exhaust line 150. Exhaust gasses from the combustion process are directed into the aftertreatment system 104 from the combustion chambers 108, through exhaust runners 117 and the exhaust manifold 116, to exhaust conduit 190 in the embodiment illustrated in FIG. 2. In other embodiments, other configurations are possible. For example, where engine 102 includes a “V” engine with two exhaust manifolds 116 (one on either side of the “V”), cylinders 108 on a first side of the “V” may direct exhaust from a first exhaust manifold 116 into a first conduit, and cylinders 108 on another second side of the “V” may direct exhaust from a second exhaust manifold 116 into a second conduit. The first and second conduits may then converge into the single conduit 190.

Conduit 190 can fluidly connect the exhaust manifold 116 with, and direct exhaust gasses to the pre-turbine module 152. The pre-turbine module 152 may include a housing 151 having an inlet port 153 and an outlet port 155 and defining a flow path between the inlet port 151 and the outlet port 155. In the illustrated embodiment, a diesel oxidation catalyst (DOC) 178 and a NOx adsorber 180 are disposed in the flow path. Alternative embodiments may not include the NOx adsorber 180, and may include other aftertreatment devices.

DOCs 178 are known in the art and can catalyze a reaction between oxygen (O₂), and hydrocarbons (HC) and/or carbon monoxide (CO) in the exhaust gasses, to form carbon dioxide (CO₂) and water (H₂O). In addition, the DOC 178 can convert nitrogen monoxide (NO) into nitrogen dioxide (NO₂) for further treatment in other aftertreatment devices. The DOC 178 can be made from metals such as palladium and platinum. Representative equations for this reaction are:

2CO+O₂→2CO₂ (2)

[HC]+O₂→CO₂+H₂O (3)

2NO+O₂→2NO₂ (4)

NOx adsorbers 180 are known in the art and may remove at least a portion of the nitrogen oxides from the exhaust gasses, at least temporarily. The NOx adsorber 180 may include a substrate such as alumina that is covered or coated with a material that will function as a nitrogen oxide absorbent by chemically converting with and absorbing nitrogen oxide. Examples of a nitrogen oxide absorbent include barium, barium carbonate, potassium, sodium and calcium. Also disposed on the substrate, in some embodiments, can be one or more catalysts that assist in trapping the nitrogen oxides. The catalyst can be formed as several rounded protrusions disposed over the substrate to increase their exposure to the exhaust gasses. A suitable material for the catalyst can include platinum. The NOx adsorber 180 can be formed as a flow-through or pass-through device with the nitrogen oxide absorbent and catalyst on a honeycombed or baffle-plated substrate.

NO_{X} molecules in the exhaust gasses can chemically react with and diffuse into the nitrogen oxide absorbent. For example, the chemical reaction may convert a portion of barium carbonate to barium nitrate according to the following representative equation:

BaCO₃+2NO₂═Ba(NO₃)₂+CO (5)

The NO_{X} adsorber 180 will adsorb NO_{X} if the exhaust gas temperature is in an adsorbent temperature range and the NO_{X} adsorber 180 has not reached capacity and saturated. If the NO_{X} adsorber 180 saturates, the NO_{X} in the exhaust gas will not be stored and will continue to flow downstream in the exhaust gases. If the exhaust gas temperature is in a desorption range, the NO_{X} adsorber 180 will release the stored NO_{X} to flow downstream in the exhaust gas.

The outlet port 155 of the pre-turbine module can fluidly connect with and direct exhaust gasses to the turbine 154 through conduit 192. Conduit 194 can fluidly connect the turbine 154 with, and direct exhaust gasses to the post-turbine module 162. The post-turbine module 162 may include a housing 161 having an inlet port 163 and an outlet port 165 and defining a flow path between the inlet port 161 and the outlet port 165.

In the illustrated embodiment, a combined diesel particulate filter, DPF, coated with a selective catalytic reduction catalyst, SCR, which may be referred to as a CDS 184, and an ammonia oxidation catalyst (AMO_{X}) 186 are disposed in the flow path. Alternative embodiments may include a separate DPF and SCR, and/or other aftertreatment devices, and/or may exclude one of the illustrated aftertreatment devices.

The CDS 184 can include a filtration substrate to remove particulate matter or soot from the exhaust gasses as is known in the art. A suitable filtration substrate can be fabricated from an electrically conductive or non-conductive coarse mesh metal or porous ceramic honeycomb medium. As exhaust flows through filtration substrate, the substrate may block particles over a certain size from passing through. These particles are left behind within the CDS 184. These particles may be incinerated by very hot exhaust gasses or removed by other methods as is known in the art.

At least a portion of filtration substrate can be coated or impregnated with a selective catalytic reduction (SCR) type catalyst, for example, vanadium on titanium or a zeolite with an active base metal formulation. The SCR coating or impregnation, in conjunction with the use of a liquid reductant, or in an alternative embodiment gaseous reductant, added to the exhaust gasses upstream of the CDS 184, can reduce NO_{X} in the exhaust gasses. For example, the reaction and reduction of NO_{X} can occur according to the following representative equation:

NH₃+NO_{X}═N₂+[H₂0] (6)

A reductant agent 182 can be provided for use with the SCR catalyst. In the illustration of FIG. 2, the reductant agent 182 is stored in the reductant tank 156. A reductant line 158 fluidly connects the reductant tank 156 to the reductant injector 160. Although illustrated disposed in conduit 194, between the turbine 154 and the post-turbine module 162, the reductant injector 160 can be disposed in the exhaust line 150 upstream or downstream of the turbine 154 to introduce the reductant 182 into the exhaust gases. Non-limiting examples of reductant 182 include pressurized urea solution, ammonia gas, liquefied anhydrous ammonia, ammonium carbonate, or an amine salt.

Reductant injector 160 (or an alternative introduction device) may introduce one or more reductants 182 into the exhaust gasses, ultimately resulting in the presence of ammonia gas (NH₃) in the exhaust gasses when they flow into the CDS 184. In some embodiments, various mixers or pre-mixers (not shown) can be disposed in the exhaust line 150 to mix the reductant 182 and exhaust gasses to ensure that adequate NH₃ is available when the exhaust gasses flow into the CDS 184. In other embodiments, conduit 194 may be shaped and of a length that ensures the reductant 182 and exhaust gasses have formed adequate amounts of NH₃ before entering the CDS 184.

The AMO_{X} 186 can oxidize NH₃ formed by the reductant and exhaust gasses, and not transformed by the SCR catalyst. AMO_{X}s 186 are known in the art. One embodiment of the AMO_{X} 186 may be based on a platinum di-aluminum tri-oxide (Pt/Al₂O₃) formulation that promotes reaction and reduction of NH₃ according to the following representative equations:

2NH₃+2O₂→N₂O+3H₂O (7)

4NH₃+3O₂→2N₂+6H₂O (8)

4NH₃+5O₂→4NO+6H₂O (9)

The outlet port 165 of the post-turbine module 165 can fluidly connect with outside air, or the environment outside the engine 102, through conduit 196, to expel the exhaust gases. In some embodiments, the exhaust gasses may flow through one or more noise suppression devices (not shown), before being expelled.

### INDUSTRIAL APPLICABILITY

Many factors must be must be taken into consideration when designing an aftertreatment system. Non-limiting examples include the effect that one aftertreatment device has on another, the exhaust temperatures at different engine operating conditions throughout the aftertreatment system, time and exhaust flow distances required for chemical reactions, exhaust back-pressure, exhaust pressure and flow at the turbine, EGR requirements, and physical size and shape. Optimizing one aspect or device of an aftertreatment system may affect another aspect and/or the operation of another device.

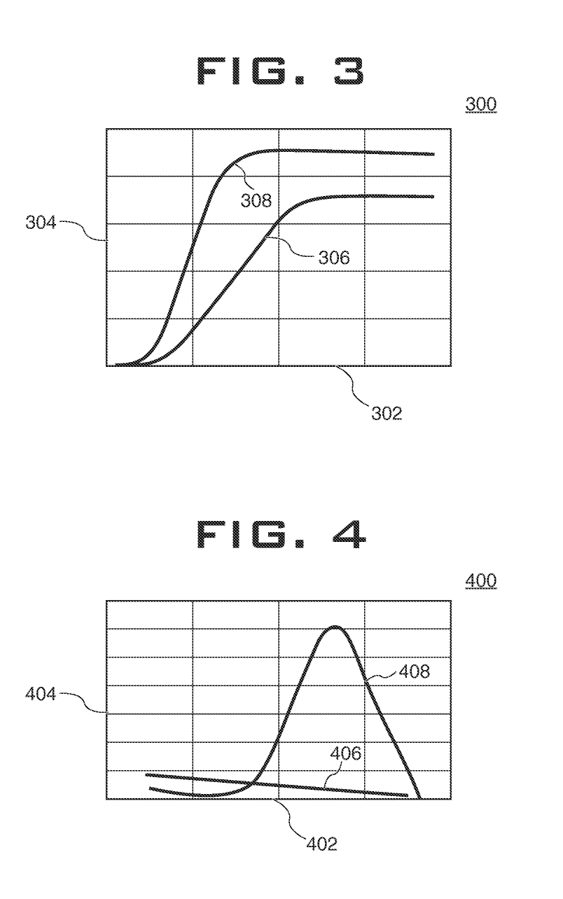

Some aftertreatment devices operate more efficiently at one temperature or in one temperature range than another. For example, the DOC 178 may operate to oxidize HCs, CO, and/or NO more efficiently at higher temperatures. Referring to FIG. 3, an exemplary graph 300 of DOC 178 conversion efficiency of HCs and CO is illustrated. The x-axis 302 represents temperature, and the y-axis 304 represents percent conversion. Line 306 represents an exemplary plot of percent conversion of HC and O₂, to CO₂ and H₂O; verses temperature. Line 308 represents an exemplary plot of percent conversion of CO and O₂, to CO₂; verses temperature. The graph 300 illustrates the increase of HC and CO conversion efficiency as exhaust gas temperatures increase. In one embodiment, the DOC 178 may convert CO and O₂, to CO₂ most efficiently when it is above two hundred and fifty degrees Celsius (250° C.); and HC and O₂, to CO₂ and H₂O when it is above three hundred degrees Celsius (300° C.).

Referring to FIG. 4, an exemplary graph 400 of NO₂ concentration verses temperature. The x-axis 402 represents temperature, and the y-axis 404 represents NO₂ concentration. Line 406 represents an exemplary plot of NO₂ concentration at the engine 102 exhaust outlet verses temperature. Line 408 represents an exemplary plot of NO₂ concentration at the DOC 178 outlet verses temperature. The graph 400 illustrates the DOC 178 increased NO conversion to NO₂ as exhaust gas temperatures increase. In one embodiment, the DOC 178 converts NO to NO₂ more efficiently when in the temperature range of three hundred degrees Celsius (300° C.) to four hundred degrees Celsius (400° C.).

In the exhaust system 148, exhaust gas temperatures may be highest close to the engine manifold 116. In one exemplary embodiment exhaust gas temperatures at the pre-turbine module 152 location may range from about two hundred degrees Celsius (200° C.) when the engine 102 is running low loads at sea level, to about seven hundred degrees Celsius (700° C.) when the engine 102 is running high loads at an elevated altitude. Exhaust gas temperatures will generally decrease as the exhaust gas flows further away from the engine manifold 116. Placement of the DOC 178 in closer proximity to the engine manifold 116 may increase the efficiency of the DOC 178 and decrease the time before the DOC 178 reaches an efficient conversion temperature after engine 102 start-up.

In an aftertreatment system 104 including a DOC 178 and an urea reductant, the DOC 178 is generally located upstream of the urea injection as the NH₃ formed from the urea mixing with the exhaust gases and undergoing thermolysis and hydrolysis will oxidize over the DOC 178 to form undesired NO_{X}, resulting in reduced NH₃ available for NO_{X} reduction downstream, while also increasing the NO_{X} present in the exhaust gases.

To achieve efficient conversion of NO_{X} when using a liquid urea reductant, aftertreatment systems are generally designed to allow sufficient mixing of the urea with exhaust gasses such that a sufficient amount of NH₃ is formed. Designers may include a hydrolysis catalyst, a mixing tube or device, a conduit of sufficient length and/or other devices to allow mixing between the injection area and the SCR catalyst. In some embodiments using urea as a reductant 182, injections into the exhaust gasses may be delayed until the exhaust gasses at the injection location reach a decomposition temperature, as the urea may not sufficiently decompose below that temperature. If the liquefied urea does not sufficiently decompose, it may form deposit formations which negatively effect the treatment of exhaust gasses. In one embodiment, the decomposition temperature may be about two hundred degrees Celsius (200° C.).

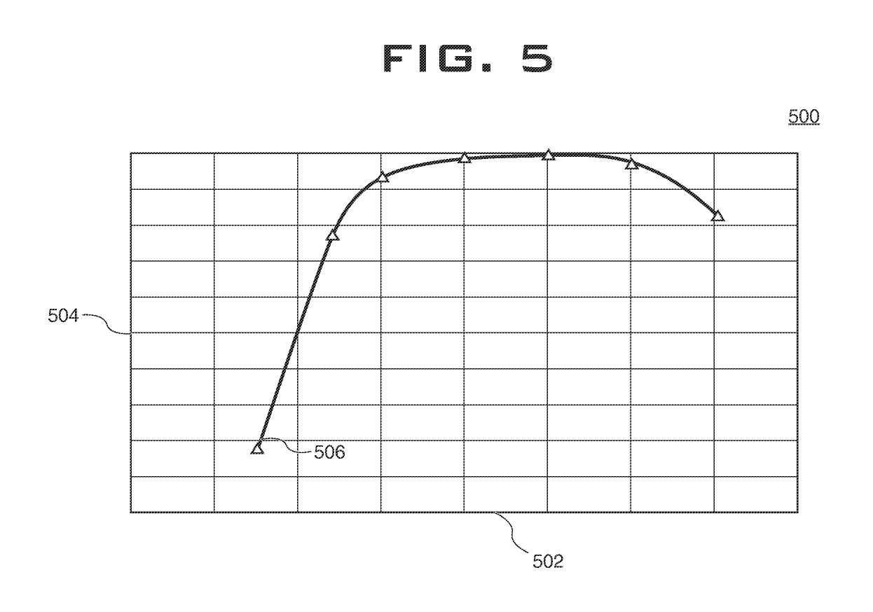

The CDS 184 may operate to convert NH₃ and NO_{X}, to N₂ and H₂O, more efficiently in higher temperatures. Referring to FIG. 5, an exemplary graph 500 of CDS 184 conversion efficiency of NO_{X} is illustrated. The x-axis 502 represents temperature, and the y-axis 504 represents percent NO_{X} conversion. Line 506 represents an exemplary plot of percent conversion of NH₃ and NO_{X}, to N₂ and H₂O; verses temperature. The graph 500 illustrates the increase of NO_{X} conversion efficiency as exhaust gas temperatures increase. In one embodiment, peak NO_{X} conversion in the CDS 184 may be in the three hundred degrees Celsius (300° C.) to four hundred degrees Celsius (400° C.) range. The range may be broadened to a two hundred fifty degrees Celsius (250° C.) to four hundred fifty degrees Celsius (450° C.) range with a more ideal NO₂ to NO_{X} ratio of about five tenths (0.5).

In an embodiment using a urea reductant 182, the engine 102 may be controlled to run in a less fuel efficient manner to meet NO_{X} emission regulations, until the CDS 184 is at a light-off temperature and exhaust gas temperatures at the urea injection location are high enough to ensure decomposition of the urea into NH₃. In aftertreatment systems where the DOC 178 is located downstream of the turbine 154, the CDS 184 (or other SCR catalyst device), generally, must be located downstream of the DOC 178 (to avoid damage) and far enough downstream of the reductant 182 injection, to allow mixing of the urea and exhaust gasses to form sufficient quantities of NH₃. The further downstream the SCR device is located, the longer the SCR device may take to reach light-off temperature after engine 102 start-up. When the DOC 178 is located upstream of the turbine 154, the CDS 184 may be located further upstream, and may reach light-off temperature more rapidly.

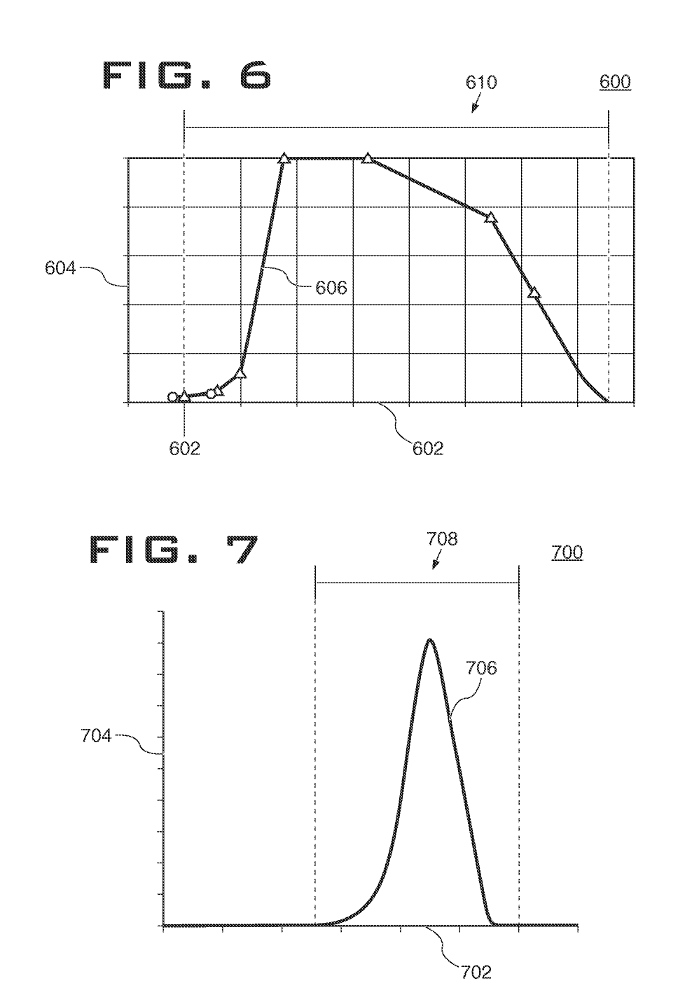

The NO_{X} adsorber 180 may adsorb NO_{X} when in an adsorption temperature range 610 (shown in relation to FIG. 6) and desorb, or release NO_{X} when in a desorption temperature range 708 (shown in relation to FIG. 7). Referring now to FIG. 6, an exemplary graph 600 of NO_{X} adsorber 180 adsorption efficiency verses temperature. The x-axis 602 represents temperature, and the y-axis 604 represents percent NO_{X} adsorption. Line 606 represents an exemplary plot of percent adsorption of NO_{X} verses temperature. The NO_{X} adsorber 180 may have a light-off temperature 608 at which it begins to adsorb NO_{X}. The graph shows an exemplary adsorption temperature range 610. In one embodiment the light-off temperature 608 may be about one hundred and fifty degrees Celsius (150° C.), and the adsorption range 610 may be from about one hundred and fifty degrees Celsius (150° C.) to about four hundred degrees Celsius (400° C.). In one embodiment, the NO_{X} adsorber 180 may adsorb NO_{X} most efficiently when in the range of two hundred degrees Celsius (200° C.) to three hundred degrees Celsius (300° C.).

When the NO_{X} adsorber 180 temperature increases above the adsorption temperature range, the NO_{X} adsorber 180 will cease adsorbing NO_{X}. If exhaust gas temperatures continue to rise, the NO_{X} adsorber 180 may reach the desorption temperature range 708 where NO_{X} adsorber 180 will desorb NO_{X}. Referring now to FIG. 7, an exemplary graph 700 of NO_{X} concentration in exhaust gas flowing out of the NO_{X} adsorber 180 verses temperature. The x-axis 702 represents temperature, and the y-axis 704 represents NO_{X} concentration. Line 706 represents an exemplary plot of NO_{X} concentration verses temperature. The graph shows an exemplary desorption temperature range 708. In one embodiment the desorption range 708 may be from about four hundred twenty-seven degrees Celsius (427° C.) to about five hundred twenty-seven degrees Celsius (527° C.).

If the NO_{X} adsorber 180 is located upstream of the turbine 154, it may reach light-off temperature faster, after engine start-up, than if it were located downstream of the turbine 154. When light-off temperature is reached, the NO_{X} adsorber 180 will begin to adsorb NO_{X} from the exhaust gases while in the adsorption temperature range 610. This may reduce the NO_{X} in the exhaust gasses such that the engine 102 may be run in a more fuel efficient manner while meeting emission regulations.

When the NO_{X} adsorber 180 temperature rises above the adsorption temperature range 610; the CDS 184 (or another SCR catalyst device) may have reached light-off temperature, and the temperature at the reductant 182 injection site may be at or above the decomposition temperature; such that reductant 182 injections may begin and the CDS 184 may convert NO_{X} at an efficiency to meet emission regulations. The further upstream the CDS 184 is located, the smaller it may be sized as the CDS 184 efficiency may increase with temperature. The NO_{X} adsorber 180 reducing NO_{X} in the exhaust gasses at lower temperatures, allows additional downsizing of the CDS 184.

When the NO_{X} adsorber 180 reaches the desorption temperature range 708, the NO_{X} adsorber 180 will begin desorbing NO_{X}, and the CDS 184 may be at a temperature where the CDS 184 is able to convert the NO_{X} such that the engine 102 can be run in a fuel efficient mode while meeting emission regulations.

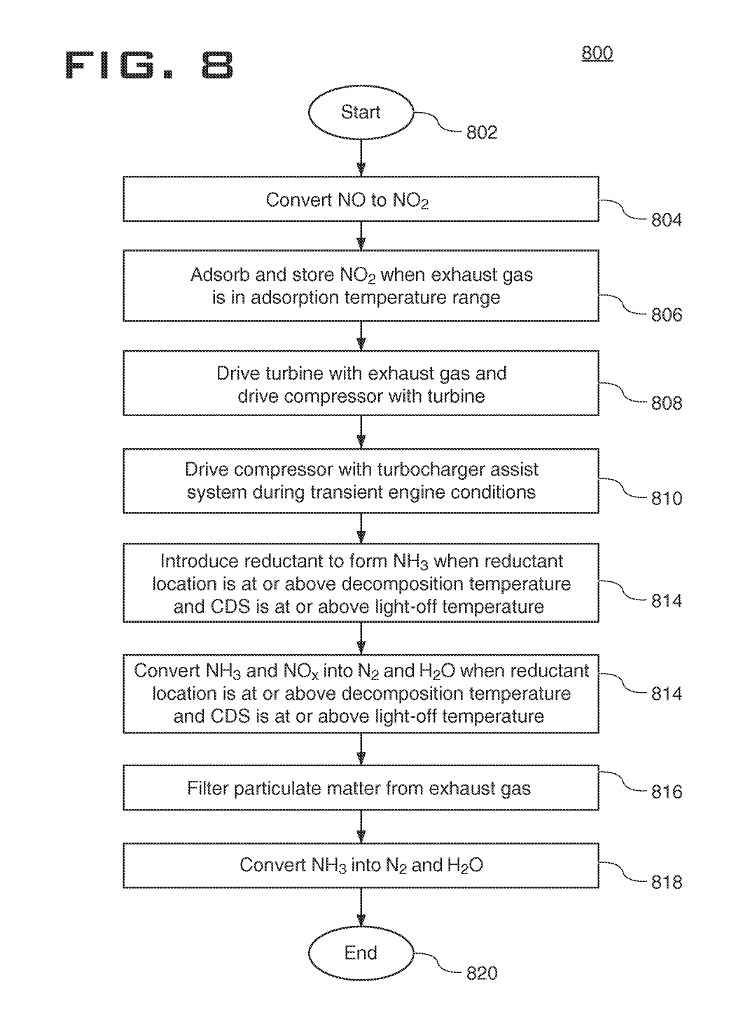

Referring now to FIG. 8, a method 800 for treating exhaust gasses is illustrated. The method 800 includes converting NO in the exhaust gas to NO₂ upstream of a turbine; adsorbing and storing NO₂ from the exhaust gas in an adsorbing location upstream of the turbine, when the temperature at the adsorbing location is in a adsorption temperature range; and introducing a reductant into the exhaust gas, in a reductant introduction location downstream of the adsorbing location, to form NH₃ in the exhaust gas, and converting the NH₃ and NO₂, into N₂ and H₂O, in an NO₂ conversion location downstream of the reductant introduction location, when the exhaust gas temperature is above a decomposition temperature at the injection location, and the exhaust gas is above a CDS light-off temperature at the CDS location. The method 800 starts at step 802 and proceeds to step 804. In step 804 NO in the exhaust gasses is converted to NO₂ upstream of a turbine 154. When the DOC 178 is disposed upstream of the turbine 154, the DOC's 178 temperature may increase more rapidly than if the DOC 178 is disposed downstream of the turbine 154, as the exhaust gasses are generally at a higher temperature upstream of the turbine 154. The DOC's 178 efficiency may increase with temperature, and thus disposing the DOC 178 upstream of the turbine may allow the DOC 178 to be designed smaller in size, and using less materials. In addition, disposing the DOC 178 upstream of the turbine 154 may result in the DOC 178 reaching a light-off temperature more rapidly after engine start-up. The method 800 proceeds to step 806.

In step 806, the NO_{X} adsorber 180 may adsorb and store NO₂ from the exhaust gasses when in an adsorption temperature range. When the NO_{X} adsorber 180 is disposed upstream of the turbine 154, the NO_{X} adsorber 180 may reach light-off temperature more rapidly than if the NO_{X} adsorber 180 was disposed downstream of the turbine 154. When an SCR catalyst device disposed downstream of the turbine 154 and a liquid reductant 182 injected downstream of the NO_{X} adsorber 180; the NO_{X} adsorber 180 may adsorb NO_{X} during a time period when the SCR catalyst has not yet reached light-off temperature and/or the temperature at the reductant 182 injection location has not yet reached the decomposition temperature. The method 800 proceeds to step 808.

In step 808, the exhaust gasses drive the turbine 154, which drives the compressor 144 as is known in the art. The method 800 proceeds to step 810.

In step 810, the supercharger assist system 145 drives the compressor 144 during a transient engine 102 condition. Aftertreatment devices, such as the DOC 178, and the NO_{X} adsorber 180, disposed upstream of the turbine 154, may reduce the exhaust gas energy at the turbine 154. A reduction in exhaust gas energy may result in less power available from the turbine 154 to drive the compressor 144. Less power available from the turbine 154 may result in the engine 102 having a slower response to transient load demands. The controller 200 may control the supercharger assist system 145 to drive the compressor 144 during an engine 102 transient load demand, to increase the rate of engine 102 response. The method 800 proceeds to step 812.

In step 812, reductant 182 is introduced into the exhaust gasses when the exhaust gasses are above the decomposition temperature at the reductant 182 introduction location, and the CDS 184 is at or above light-off temperature. The reductant 182 can mix with the exhaust gasses to form NH₃. The method 800 proceeds to step 814.

In step 814, NH₃ and NO_{X} are converted to N₂ and H₂O when the exhaust gasses are above the decomposition temperature at the reductant 182 introduction location, and the CDS 184 is at or above light-off temperature. Once the temperature is high enough at the reductant 182 introduction location and the CDS 184 has reached light-off temperature, the CDS 184 may begin to convert NH₃ and NO_{X} to N₂ and H₂O. The method proceeds to step 816.

In step 816, particulate matter is filtered from the exhaust gas. When the aftertreatment system 104 includes the CDS 184, the CDS 184 can filter particulate matter from the exhaust gas as is known in the art. In other embodiments a particulate filter may be provided separate from an SCR catalyst device, and/or the particulate filter may be combined with another aftertreatment device. The method 800 proceeds to step 818.

In step 818 the AMO_{X} may convert NH₃ which has not reacted with NO_{X} to form N₂ and H₂O in the CDS 184 (or other SCR catalyst device), to N₂ and H₂O, as is known in the art. The method 800 proceeds to step 820 and ends.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

What is claimed is:

1. An engine exhaust gas treatment system, comprising:
an oxidation catalyst fluidly connected to an exhaust manifold of the engine,
a NO_{X} adsorber fluidly connected to the exhaust manifold, and
one or more turbines, each turbine fluidly connected to and downstream of the oxidation catalyst and the NOx adsorber.

2. The system of claim 1, wherein the oxidation catalyst is upstream of the NO_{X} adsorber.

3. The system of claim 1, further including
an exhaust line fluidly,
an intake air line fluidly, and
an EGR conduit fluidly connecting the exhaust line with the intake air line, and
wherein the oxidation catalyst, the NO_{X} adsorber, and the one or more turbines are disposed on the exhaust line.

4. The system of claim 1, wherein at least one of the turbines is drivingly connected to a compressor for compressing and directing intake air into an intake manifold of the engine, and further including a supercharger assist system selectively drivingly connected to the compressor.

5. The system of claim 4, further including;
a high pressure exhaust conduit fluidly connecting the exhaust manifold with the oxidation catalyst,
a high pressure intake air conduit fluidly connecting the compressor with the intake manifold, and
a high pressure EGR conduit fluidly connecting the high pressure exhaust conduit with the high pressure intake conduit.

6. The system of claim 4, further including;
a low pressure exhaust conduit downstream of the at least one of the turbines,
a low pressure intake air conduit fluidly connecting the compressor with an air inlet, and
a low pressure EGR conduit fluidly connecting the low pressure exhaust conduit with the low pressure intake conduit.

7. The system of claim 1, further including a selective catalytic reduction catalyst fluidly connected to and downstream of the one or more turbines.

8. The system of claim 1, further including a particulate filter coated with a selective catalytic reduction catalyst fluidly connected to and downstream of the one or more turbines.

9. The system of claim 8, further including an ammonia oxidation catalyst fluidly connected to and downstream of the particulate filter,

10. The system of claim 9,
further including a housing having an inlet port and an outlet port and defining a flow path between the inlet port and the outlet port, the housing fluidly connected to and downstream of the one or more turbines, and
wherein the particulate filter and the ammonia oxidation catalyst are disposed in the flow path.

11. The system of claim 1, further including an injector configured to direct a spray of reductant into exhaust gas downstream of the one or more turbines.

12. The system of claim 1, further including an injector configured to direct a spray of reductant into exhaust gas upstream of at least one of the one or more turbines.

13. An engine exhaust gas treatment system, comprising:
an oxidation catalyst fluidly connected to an engine exhaust manifold,
a turbine fluidly connected to and downstream of the oxidation catalyst,
a housing having an inlet port and an outlet port and defining a flow path between the inlet port and the outlet port, the housing downstream of the turbine, and
a particulate filter coated with a selective catalytic reduction catalyst arranged in the flow path.

14. The system of claim 13, wherein the turbine is drivingly connected to a compressor for compressing and directing intake air into an intake manifold of the engine, and further including a supercharger assist system to selectively drive the compressor.

15. The system of claim 13, further including an ammonia oxidation catalyst arranged in the flow path downstream of the particulate filter.

16. The system of claim 13, further including an injector configured to direct a spray of reductant into exhaust gas downstream of the turbine.

17. The system of claim 13, further including an injector configured to direct a spray of reductant into exhaust gas upstream of the turbine.

18. A method of treating exhaust gas, comprising:
converting NO in the exhaust gas to NO₂ upstream of a turbine,
adsorbing and storing NO_{X} from the exhaust gas in an adsorbing location upstream of the turbine, when the temperature at the adsorbing location is in an adsorption temperature range,
determining an exhaust gas temperature at a reductant introduction location is above a decomposition temperature,
determining that a CDS is at or above a CDS light-off temperature, and
introducing a reductant into the exhaust gas, in the reductant introduction location downstream of the adsorbing location, to form NH₃ in the exhaust gas after determining the exhaust gas temperature at the reductant introduction location is above a decomposition temperature and the CDS is above the CDS light-off temperature, and
converting the NH₃ and NO_{X}, into N₂ and H₂O, in an NO_{X} conversion location downstream of the reductant introduction location.

19. The method of claim 18, further including converting NH₃ into N₂ and H₂O, downstream of the NO_{X} conversion location.

20. The method of claim 18, further including releasing NO₂ into the exhaust gas in the adsorbing location when the exhaust gas temperature in the adsorbing location is in a desorption range.

21. The method of claim 18, further including driving the turbine with the exhaust gas and introducing the reductant downstream of the turbine.

22. The method of claim 21, further including driving a compressor with the turbine, and driving the compressor with a supercharger assist system during a transient engine condition.

23. The method of claim 18, further including filtering particulate matter from the exhaust gas.
